(19) United States
(12) Patent Application Publication
(10) Pub. No.: US 2020/0182456 A1
(43) Pub. Date: Jun. 11, 2020

(54) COMBUSTION CHAMBER ASSEMBLY UNIT

(71) Applicant: Eberspächer Climate Control Systems GmbH & Co. KG, Esslingen (DE)

(72) Inventors: Michael HUMBURG, Göppingen (DE); Walter BLASCHKE, Deizisau (DE)

(21) Appl. No.: 16/705,553

(22) Filed: Dec. 6, 2019

(30) Foreign Application Priority Data
Dec. 7, 2018 (DE) 10 2018 131 253.9

(51) Int. Cl. F23D 3/40; F23D 5/12; B60H 1/22

(52) U.S. Cl. CPC F23D 3/40; F23D 5/123; B60H 1/2203; B60H 2001/2284; F23D 2207/00; F23D 2900/21002; B60H 2001/2271; F23D 2900/05002

(57) ABSTRACT

A fuel-operated vehicle heater, combustion chamber assembly unit includes a combustion chamber housing (14) having a combustion chamber bottom (18) and a combustion chamber circumferential wall (16) extending in a housing longitudinal axis (L) direction to define a combustion chamber (20). A porous evaporator medium (60) is on the combustion chamber circumferential wall or/and the combustion chamber bottom, at an inner side facing the combustion chamber. A fuel feed line (62) feeds liquid fuel into the porous evaporator medium. A first combustion air feed device (68), associated with the combustion chamber bottom, feeds primary combustion air (VP) into a first combustion zone (50) at which the porous evaporator medium is arranged. A second combustion air feed device (70), following the first combustion zone in the housing longitudinal axis direction feeds secondary combustion air (VS) into the combustion chamber at an axially spaced location from the first combustion zone.

### CROSS REFERENCE TO RELATED APPLICATIONS

This application claims the benefit of priority under 35 U.S.C. § 119 of German Application 10 2018 131 253.9, filed Dec. 7, 2018, the entire contents of which are incorporated herein by reference.

### TECHNICAL FIELD

The present invention pertains to a combustion chamber assembly unit for a fuel-operated vehicle heater, comprising a combustion chamber housing with a combustion chamber bottom and with a combustion chamber circumferential wall elongated in the direction of a housing longitudinal axis and arranged enclosing the housing longitudinal axis, wherein the combustion chamber bottom and the combustion chamber circumferential wall define a combustion chamber; a porous evaporator medium on an inner side of the combustion chamber circumferential wall or/and of the combustion chamber bottom, which inner side faces the combustion chamber, as well as a fuel feed line for feeding liquid fuel into the porous evaporator medium.

### TECHNICAL BACKGROUND

A combustion chamber assembly unit, in which a combustion air introduction attachment arranged concentrically in relation to the housing longitudinal axis is arranged at the combustion chamber bottom with a plurality of combustion air introduction openings in a circumferential wall thereof combustion chamber, is known from DE 102 00 524 C1. A porous evaporator medium, into which liquid fuel is fed, is provided on an inner side of a combustion chamber circumferential wall, which inner side faces a combustion chamber. The fuel released in the gaseous form from the evaporator medium into the combustion chamber mixes with the combustion air entering the combustion chamber from the combustion air introduction attachment, so that a mixture of combustion air and fuel is generated, the combustion of which leads to the formation of combustion waste gas transporting heat.

### SUMMARY

An object of the present invention is to provide a combustion chamber assembly unit and a process for operating a vehicle heater equipped with such a combustion chamber assembly unit, in which combustion chamber assembly unit and vehicle heater the percentage of pollutants, especially the percentage of nitrogen oxides and the percentage of carbon monoxide, in the waste gas generated during the combustion is reduced.

According to a first aspect, this object is accomplished by a combustion chamber assembly unit for a fuel-operated vehicle heater, comprising:
a combustion chamber housing with a combustion chamber bottom and with a combustion chamber circumferential wall, which is elongated in the direction of the housing longitudinal axis and is arranged such that it encloses the housing longitudinal axis, wherein the combustion chamber bottom and the combustion chamber circumferential wall define a combustion chamber,
a porous evaporator medium on an inner side of the combustion chamber circumferential wall or/and of the combustion chamber bottom, which inner side faces the combustion chamber,
a fuel feed line for feeding liquid fuel into the porous evaporator medium,
a first combustion zone with a first combustion air feed device associated with the combustion chamber bottom for feeding primary combustion air into the combustion chamber, wherein the porous evaporator medium is arranged in the first combustion zone, and
a second combustion zone following the first combustion zone in the direction of the housing longitudinal axis with a second combustion air feed device associated with the combustion chamber circumferential wall for feeding secondary combustion air at an axially spaced location from the first combustion zone into the combustion chamber.

Due to the provision of two combustion zones in the combustion chamber, the percentage of nitrogen oxide in the combustion waste gas can be reduced in the first combustion zone, in which the mixture of combustion air and fuel is generated and burned, during a combustion at a comparatively high temperature. Since complete combustion of the mixture provided in the first combustion zone will not take place in the first combustion zone, but a percentage of unburned fuel and primary air or oxygen contained therein will enter the second combustion zone and will be mixed with the secondary air there, the combustion can take place in the second combustion zone based on the temperature of the secondary air introduced into the second combustion zone, on the one hand, and based on the increased total percentage of air in the mixture to be burned therein, on the other hand, such that the percentage of carbon monoxide in the combustion waste gas is reduced, so that the combustion waste gas leaving the combustion chamber or a flame tube following it has both a markedly reduced percentage of nitrogen oxides, and also a markedly reduced percentage of carbon monoxide.

To provide the two combustion zones, it is proposed that the first combustion air feed device comprise a combustion air introduction attachment projecting at the combustion chamber bottom in the direction of the combustion chamber, wherein a plurality of first combustion air introduction openings are provided in a circumferential wall or/and in a bottom of the combustion air introduction attachment, which bottom is offset in the direction of the housing longitudinal axis, and that the second combustion air feed device comprise a plurality of second combustion air introduction openings in an area of the combustion chamber circumferential wall, which area is located at an axially spaced location from the bottom of the combustion air introduction attachment.

Provisions may be made for an improved mixing of fuel and combustion air for the first combustion air feed device to comprise a swirl-generating device for introducing the primary combustion air with a swirl in relation to the housing longitudinal axis into the combustion air introduction attachment upstream of the combustion air introduction attachment, or/and for the second combustion air feed device to comprise a combustion air feed chamber enclosing the combustion chamber circumferential wall.

To guarantee that fuel is fed into the combustion chamber only in the area of the first combustion zone, it is proposed that the porous evaporator medium extend on an inner side of the combustion chamber circumferential wall starting from the combustion chamber bottom axially beyond the combustion air introduction attachment and that the second combustion air introduction openings be arranged at an axially spaced location from the porous evaporator medium.

To make it possible to set defined combustion conditions in the two combustion zones, which guarantee that the combustion can take place in the two combustion zones with a respective mixing ratio of combustion air and fuel that is suitable for a reduced percentage of pollutants and at temperatures that are optimal for a low percentage of pollutants, provisions may be made according to the present invention for the first combustion air feed device and the second combustion air feed device to be configured such that 57% to 61%, preferably about 59%, of the combustion air introduced into the combustion chamber enters the combustion chamber as primary combustion air and 39% to 43%, preferably about 41%, of the combustion air introduced into the combustion chamber enters the combustion chamber as secondary combustion air.

The present invention further pertains to a fuel-operated vehicle heater, comprising a combustion chamber assembly unit having the configuration described above, a fuel pump for feeding fuel into the fuel feed line and a combustion air blower for feeding combustion air as primary combustion air and secondary combustion air into the combustion chamber.

According to another aspect, the object described in the introduction is accomplished by a process for operating a vehicle heater configured according to the present invention, in which process combustion air and fuel are fed to the combustion chamber assembly unit at such flow rates that the primary combustion air and the fuel can be fed at a quantity ratio for a combustion with a lambda value in the range of 1-1.15 and preferably about 1, into the first combustion zone.

Combustion with such a mixing ratio guarantees, on the one hand, that a combustion temperature necessary for a low percentage of nitrogen oxides in the combustion waste gas will be reached in the first combustion zone, but it also guarantees, on the other hand, that complete reaction of the oxygen contained in the primary combustion air and of the fuel fed into the first combustion zone cannot occur in the first combustion zone, so that unburned primary combustion air flowing from the first combustion zone into the second combustion zone and unburned fuel can mix with the secondary combustion air and can then lead to an essentially complete combustion at a lower combustion temperature.

Further, combustion air and fuel can be fed to the combustion chamber assembly unit at such flow rates that the primary combustion air and secondary combustion air and the fuel are fed into the combustion chamber at a quantity ratio for a combustion with a lambda value in the range of 1.6 to 1.8 and preferably about 1.7. This quantity ratio, which is related to the total quantity of combustion air fed into the combustion chamber and the total quantity of fuel introduced into the combustion chamber, guarantees that the fuel can be burnt essentially completely with reduced pollutant contents in the combustion waste gas, especially with reduced percentage of nitrogen oxides and reduced percentage of carbon monoxide during the combustions, which also take place essentially in two combustion phases at different temperatures in the two combustion zones.

The present invention will be described below in detail with reference to the attached figures. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a longitudinal sectional view of a combustion chamber assembly unit for a fuel-operated vehicle heater; and

FIG. 2 is a cross-sectional view of the combustion chamber assembly unit according to FIG. 1, cut along a line II-II in FIG. 1.

### DESCRIPTION OF PREFERRED EMBODIMENTS

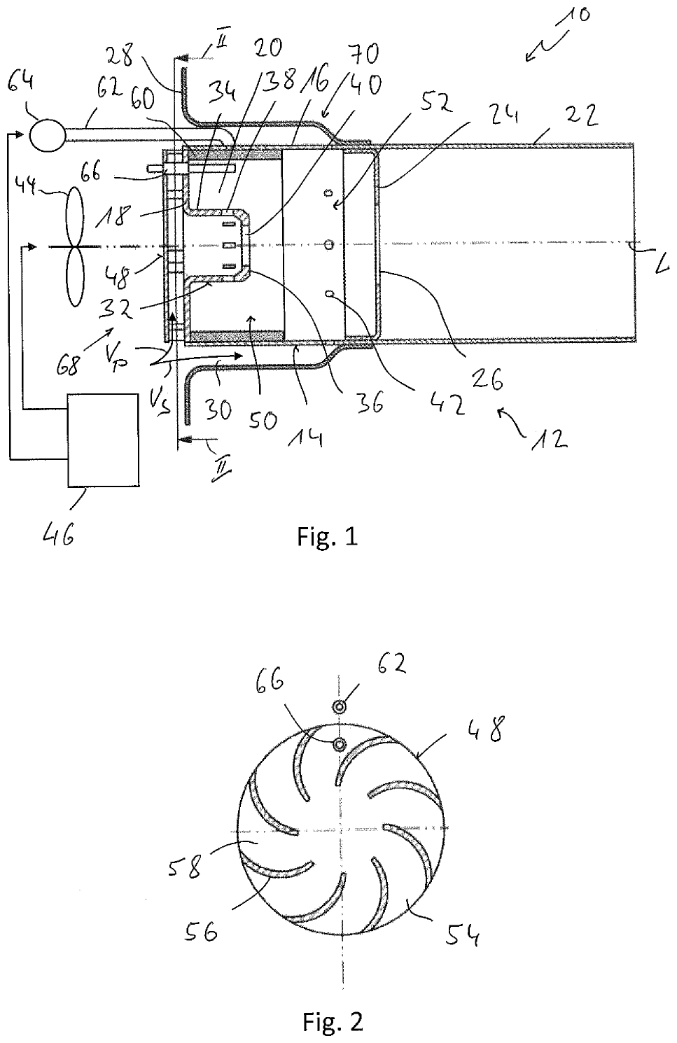

Referring to the drawings, a combustion chamber assembly unit of a vehicle heater generally designated by 10 is designated by 12 in FIG. 1. The combustion chamber assembly unit 12 comprises a combustion chamber housing 14 with a combustion chamber circumferential wall 16 elongated in the direction of a housing longitudinal axis L and with a bottom wall 18 adjoining the combustion chamber circumferential wall at an axial end area of the combustion chamber circumferential wall 16. The combustion chamber circumferential wall 16 and the bottom wall 18 define a combustion chamber 20. The combustion chamber circumferential wall 16 is configured integrally in the example shown with a flame tube 22, wherein a flame diaphragm 24 with a central opening 26 is arranged in the transition area between the combustion chamber circumferential wall 16 and the flame tube 22 adjoining same.

An outer circumferential wall 28 is connected on the outside to the combustion chamber circumferential wall 16 or to the flame tube 22. This outer circumferential wall 28 defines, together with the combustion chamber circumferential wall 16, a combustion air feed chamber 30 enclosing the combustion chamber circumferential wall 16 or the combustion chamber 20 in a ring-like manner. A combustion air introduction attachment 32 is provided at the combustion chamber bottom 18, arranged in a central area or centered in relation to the housing longitudinal axis L. A circumferential wall 34 of the combustion air introduction attachment adjoins the combustion chamber bottom 18. In an axial end area of the circumferential wall 34 of the combustion air introduction attachment 32, which end area is located at a spaced location from the combustion chamber bottom 18, a bottom 36 of the combustion air introduction attachment 32 adjoins this circumferential wall 34. The combustion air introduction attachment 32 is open to the combustion chamber 20 via a plurality of first combustion air introduction openings 38 provided in the circumferential direction following each other around the housing longitudinal axis in the circumferential wall 34 and via a first combustion air introduction opening 40 provided in the bottom 36. The combustion air feed chamber 30 is open towards the combustion chamber 20 via a plurality of second combustion air introduction openings 42, which follow one another in the circumferential direction around the housing longitudinal axis L and are arranged, for example, in a ring-like configuration.

A combustion air blower 44 is provided for feeding combustion air into the combustion chamber 20. This combustion air blower 44, configured as a side channel blower, is actuated by an actuating device 46 and can be operated to feed the combustion air necessary for the combustion. A part of the combustion air being fed by the combustion air blower 44 flows as primary combustion air VP over a swirl-generating device 48 in the direction of the combustion air introduction attachment 32 and via the first combustion air introduction openings 38, 40 into a first combustion zone 50 of the combustion chamber 20. Another part or the rest of the combustion air fed by the combustion air blower 44 flows as secondary combustion air VS into the combustion air feed chamber 30 and via the second combustion air introduction openings 42 into a second combustion zone 52 of the combustion chamber 20, which said combustion zone follows the first combustion zone 50 axially.

The swirl-generating device 48 is shown in more detail in FIG. 2. This comprises, at a spaced location from the combustion chamber bottom 18, a bottom plate 54, which is located essentially parallel to this combustion chamber bottom 18, and a plurality of combustion air introduction elements 56 following one another with a spiral contour in the circumferential direction. These elements 56 may be in contact with the rear side of the combustion air bottom 18, which rear side faces away from the combustion chamber 20, so that respective, spirally extending combustion air introduction ducts 58 are formed between the combustion chamber bottom 18, the bottom plate 54 and the combustion air introduction elements 56. The primary combustion air VP flowing into the combustion air introduction ducts 58 from the racially outer direction is thus converted into a swirling flow and enters into the interior of the combustion air introduction connection piece 32 and through the first combustion chamber introduction openings 38, 40 into the first combustion zone 50 of the combustion chamber 20 with a swirl, i.e., essentially also in a swirled state.

A porous evaporator medium 60 is provided in the first combustion zone 50 on an inner side of the combustion chamber circumferential wall 16, which inner side faces the combustion chamber 20, for feeding the fuel necessary for the combustion into the combustion chamber 20. This porous evaporator medium, made of a metal mesh, metal fabric, foam ceramic or other material having a pore-like structure, absorbs the liquid fuel being fed by a fuel pump 64 via a fuel feed line 62, distributes same by capillary feeding action in its inner volume area and releases the fuel in the first combustion zone 50 in a gaseous state of aggregation into the combustion chamber 20. This fuel fed into the combustion chamber 20 mixes in the first combustion zone 50 with the primary combustion air VP introduced into this combustion zone via the first fuel feed openings 38, 40 and thus provides an ignitable or combustible mixture of fuel and primary combustion air in the first combustion zone 50. To ignite this mixture and thus to start the combustion, an ignition element 66, configured, for example, as a glow-type ignition pin, is carried at the combustion chamber bottom 18 in the example being shown, so that the thermally active area of said glow-type ignition pin is located at a short distance opposite the porous evaporator medium. The ignition element 66, just like the fuel pump 64, may also be actuated by the actuating device 46 in order to provide the mixture of fuel and combustion air, which mixture is suitable for a combustion, in the combustion chamber 20, on the one hand, and, on the other hand, to ignite this mixture in the first combustion zone 50 at the beginning of a combustion operation by energizing the ignition element 66 by a suitable actuation of the combustion air blower 44, the fuel pump 64 and the ignition element 66.

In the configuration of a combustion chamber assembly unit 12 described above in reference to FIG. 1, a first combustion air feed device 68 provided for feeding the primary combustion air VP comprises, in addition to the combustion air blower 44, the swirl-generating device 48 and the combustion air introduction attachment 32 provided at the combustion chamber bottom 18 with the first combustion air introduction openings 38, 40 formed therein. A second combustion air feed device provided for feeding the secondary combustion air VS to the second combustion zone 52 comprises, in addition to the combustion air blower 44, the fuel feed chamber 30 and the second combustion air introduction openings 42 providing a connection between the fuel feed chamber 30 and the combustion chamber 20 in the second combustion zone 52.

The two combustion air feed devices 68, 70 are configured with the different volume areas provided in them, through which the primary combustion air VP and the secondary combustion air VS flow, and with openings such that the combustion air being fed by the combustion air blower during the operation of said combustion air blower 44 is split into the flow component primary combustion air VP and the flow component secondary combustion air VS such that 57% to 61% and preferably about 59% of the total combustion air being fed by the combustion air blower 44 is introduced as primary combustion air VP into the first combustion zone 50, while the secondary combustion air VS introduced into the second combustion zone 52 equals 39% to 43% and preferably about 41% of the total quantity of combustion air being fed by the combustion air blower 44. Since the combustion air blower 44 generates both the flow of the primary combustion air VP and the flow of the secondary combustion air VS, this splitting into the two flows is defined and set essentially by the flow resistance provided in the area of a respective combustion air feed device 68, 70.

Further, the fuel pump 64 and the combustion air blower 44 are actuated during the combustion operation such that the primary combustion air VP introduced into the first combustion zone 50 and the fuel fed into the porous evaporator medium 60 and via this into the first combustion zone 50 are provided at a quantity ratio that leads or would lead to a combustion with a lambda value in the range of 1 to 1.15 and preferably 1. This means that fuel and primary combustion air VP could be burned basically completely with one another in the first combustion zone 50, without unburned fuel being carried along in the combustion waste gas then leaving the combustion chamber 20. Based on the continuous feed of fuel and primary combustion air VP, there is, however, a corresponding continuous flow of mixture generated in the first combustion zone 50 from the first combustion zone 50 into the second combustion zone 52. This means that the total quantity of mixture provided at an essentially stoichiometric mixing ratio in the first combustion zone 50 is not burned in the first combustion zone 50. A part of the mixture generated in the first combustion zone 50 enters the then following, second combustion zone 52 from the first combustion zone 50, which also ends essentially in the axial end area of the porous evaporator medium 60, and is mixed there with the secondary combustion air VS fed via the second combustion air introduction openings 42. An air or oxygen excess will thus develop, which leads to a superstoichiometric combustion in the second combustion zone 52 and also farther downstream in the then following flame tube 22. On the whole, the combustion air and the fuel are introduced into the combustion chamber 20 at a quantity ratio that corresponds to a combustion with a lambda value in the range of about 1.7 and leads to such a combustion.

A combustion temperature in the range of 1,000° C. to 1,050° C. is reached with the above-described operation of the combustion chamber assembly unit 12 and of the combustion vehicle heater 10 comprising this in the first combustion zone with the essentially stoichiometric mixture of fuel and primary combustion air VP provided there. Such a high combustion temperature leads to the combustion waste gas generated in the process containing only a low percentage of nitrogen oxides. The secondary combustion air VS introduced into the second combustion zone 52 while flowing around the combustion chamber circumferential wall 16 will have a temperature of a few 100° C. below the combustion temperature prevailing in the first combustion zone 50, for example, a temperature in the range of 400° C. to 500° C., on entry into the second combustion zone 52. This leads, even when taking into account the above-mentioned quantity ratio of primary combustion air VP to secondary combustion air VS, to a combustion taking place at a markedly lower temperature in the range of about 700° C. to 800° C. in the second combustion zone 52. This combustion, taking place at a lower temperature, leads to a marked reduction of the percentage of carbon monoxide in the waste gas, so that a lower percentage of nitrogen oxides, on the one hand, and a lower percentage of carbon monoxide, on the other hand, can be reached in the combustion waste gas with the two-step combustion process taking place at two different combustion temperatures in the two combustion zones 50, 52. Decisive are for this, on the one hand, the defined splitting of the combustion air flow into the primary combustion air VP and the secondary combustion air VS, in order to make it possible to provide the respective necessary quantities of combustion air or oxygen in the two combustion zones 50, 52, and, on the other hand, the provision of an essentially stoichiometric or slightly superstoichiometric mixture of primary combustion air VP and fuel in the first combustion zone.

It becomes possible due to the setting of the flow ratios or flow resistances and consequently due to the splitting of the combustion air flow into the primary combustion air VP and the secondary combustion air VS to influence the combustion temperature especially in the second combustion zone 52 and to set it at a suitable value for a particular type of a vehicle heater 10, for example, also as a function of the heat output to be provided by the vehicle heater. The external configuration of the vehicle heater 10 corresponds here, especially with the components ensuring the connection to other system areas, to a standard configuration, so that the combustion chamber assembly unit 12 configured according to the present invention can be integrated into already existing vehicle heaters in order to make it possible to achieve the combustion operation taking place in two combustion zones in a defined manner and hence a reduced pollutant discharge there as well.

While specific embodiments of the invention have been shown and described in detail to illustrate the application of the principles of the invention, it will be understood that the invention may be embodied otherwise without departing from such principles.

What is claimed is:

1. A fuel-operated vehicle heater, combustion chamber assembly unit comprising:
a combustion chamber housing comprising a combustion chamber bottom and a combustion chamber circumferential wall elongated in a direction of a housing longitudinal axis and arranged enclosing the housing longitudinal axis, wherein the combustion chamber bottom and the combustion chamber circumferential wall define a combustion chamber;
a porous evaporator medium on an inner side of the combustion chamber circumferential wall or/and on an inner side of the combustion chamber bottom, which inner side faces the combustion chamber;
a fuel feed line for feeding liquid fuel into the porous evaporator medium;
a first combustion zone with a first combustion air feed device associated with the combustion chamber bottom for feeding primary combustion air into the combustion chamber, wherein the porous evaporator medium is arranged in the first combustion zone; and
a second combustion zone, following the first combustion zone in the direction of the housing longitudinal axis, with a second combustion air feed device associated with the combustion chamber circumferential wall for feeding secondary combustion air into the combustion chamber at an axially spaced location from the first combustion zone.

2. A fuel-operated vehicle heater, combustion chamber assembly unit in accordance with claim 1, wherein:
the first combustion air feed device comprises a combustion air introduction attachment projecting in a direction of the combustion chamber at the combustion chamber bottom;
a plurality of first combustion air introduction openings are provided in a circumferential wall of the combustion air introduction attachment or/and in a bottom of the combustion air introduction attachment, which bottom is offset in the direction of the housing longitudinal axis in relation to the combustion chamber bottom; and
the second combustion air feed device comprises a plurality of second combustion air introduction openings in an area of the combustion chamber circumferential wall, which area is located at an axially spaced location in relation to the bottom of the combustion air introduction attachment.

3. A fuel-operated vehicle heater, combustion chamber assembly unit in accordance with claim 2, wherein:
the first combustion air feed device comprises, upstream in relation to the combustion air introduction attachment, a swirl-generating device for introducing the primary combustion air with a swirl in relation to the housing longitudinal axis into the combustion air introduction attachment; or
the second combustion air feed device comprises a combustion air feed chamber enclosing the combustion chamber circumferential wall; or
the first combustion air feed device comprises, upstream in relation to the combustion air introduction attachment, a swirl-generating device for introducing the primary combustion air with a swirl in relation to the housing longitudinal axis into the combustion air introduction attachment and the second combustion air feed device comprises a combustion air feed chamber enclosing the combustion chamber circumferential wall.

4. A fuel-operated vehicle heater, combustion chamber assembly unit in accordance with claim 2, wherein:
the porous evaporator medium extends on the inner side of the combustion chamber circumferential wall, starting from the combustion chamber bottom, axially beyond the combustion air introduction attachment; and
the second combustion air introduction openings are arranged at an axially spaced location from the porous evaporator medium.

5. A fuel-operated vehicle heater, combustion chamber assembly unit in accordance with claim 1, wherein the first combustion air feed device and the second combustion air feed device are configured such that 57% to 61% of the combustion air introduced into the combustion chamber enters the combustion chamber as primary combustion air and 39% to 43% of the combustion air introduced into the combustion chamber enters the combustion chamber as secondary combustion air.

6. A fuel-operated vehicle heater comprising:
a combustion chamber assembly unit comprising:
a combustion chamber housing comprising a combustion chamber bottom and a combustion chamber circumferential wall elongated in a direction of a housing longitudinal axis and arranged enclosing the housing longitudinal axis, wherein the combustion chamber bottom and the combustion chamber circumferential wall define a combustion chamber;
a porous evaporator medium on an inner side of the combustion chamber circumferential wall or/and on an inner side of the combustion chamber bottom, which inner side faces the combustion chamber;
a fuel feed line for feeding liquid fuel into the porous evaporator medium;
a first combustion zone with a first combustion air feed device associated with the combustion chamber bottom for feeding primary combustion air into the combustion chamber, wherein the porous evaporator medium is arranged in the first combustion zone; and
a second combustion zone, following the first combustion zone in the direction of the housing longitudinal axis, with a second combustion air feed device associated with the combustion chamber circumferential wall for feeding secondary combustion air into the combustion chamber at an axially spaced location from the first combustion zone;
a fuel pump for feeding fuel into the fuel feed line; and
a combustion air blower for feeding combustion air as primary combustion air and as secondary combustion air into the combustion chamber.

7. A fuel-operated vehicle heater in accordance with claim 6, wherein:
the first combustion air feed device comprises a combustion air introduction attachment projecting in a direction of the combustion chamber at the combustion chamber bottom;
a plurality of first combustion air introduction openings are provided in a circumferential wall of the combustion air introduction attachment or/and in a bottom of the combustion air introduction attachment, which bottom is offset in the direction of the housing longitudinal axis in relation to the combustion chamber bottom; and
the second combustion air feed device comprises a plurality of second combustion air introduction openings in an area of the combustion chamber circumferential wall, which area is located at an axially spaced location in relation to the bottom of the combustion air introduction attachment.

8. A fuel-operated vehicle heater in accordance with claim 7, wherein:
the first combustion air feed device comprises, upstream in relation to the combustion air introduction attachment, a swirl-generating device for introducing the primary combustion air with a swirl in relation to the housing longitudinal axis into the combustion air introduction attachment; or
the second combustion air feed device comprises a combustion air feed chamber enclosing the combustion chamber circumferential wall; or
the first combustion air feed device comprises, upstream in relation to the combustion air introduction attachment, a swirl-generating device for introducing the primary combustion air with a swirl in relation to the housing longitudinal axis into the combustion air introduction attachment and the second combustion air feed device comprises a combustion air feed chamber enclosing the combustion chamber circumferential wall.

9. A fuel-operated vehicle heater in accordance with claim 7, wherein:
the porous evaporator medium extends on the inner side of the combustion chamber circumferential wall, starting from the combustion chamber bottom, axially beyond the combustion air introduction attachment; and
the second combustion air introduction openings are arranged at an axially spaced location from the porous evaporator medium.

10. A fuel-operated vehicle heater in accordance with claim 6, wherein the first combustion air feed device and the second combustion air feed device are configured such that 57% to 61% of the combustion air introduced into the combustion chamber enters the combustion chamber as primary combustion air and 39% to 43% of the combustion air introduced into the combustion chamber enters the combustion chamber as secondary combustion air.

11. A process for operating a vehicle heater, the process comprising the steps of:
providing a fuel-operated vehicle heater comprising: a combustion chamber assembly unit comprising a combustion chamber housing comprising a combustion chamber bottom and a combustion chamber circumferential wall elongated in a direction of a housing longitudinal axis and arranged enclosing the housing longitudinal axis, wherein the combustion chamber bottom and the combustion chamber circumferential wall define a combustion chamber, a porous evaporator medium on an inner side of the combustion chamber circumferential wall or/and on an inner side of the combustion chamber bottom, which inner side faces the combustion chamber, a fuel feed line for feeding liquid fuel into the porous evaporator medium, a first combustion zone with a first combustion air feed device associated with the combustion chamber bottom for feeding primary combustion air into the combustion chamber, wherein the porous evaporator medium is arranged in the first combustion zone and a second combustion zone, following the first combustion zone in the direction of the housing longitudinal axis, with a second combustion air feed device associated with the combustion chamber circumferential wall for feeding secondary combustion air into the combustion chamber at an axially spaced location from the first combustion zone; a fuel pump for feeding fuel into the fuel feed line; and a combustion air blower for feeding combustion air as primary combustion air and as secondary combustion air into the combustion chamber;
feeding combustion air and fuel to the combustion chamber assembly unit at such flow rates that the primary combustion air and the fuel are fed into the first combustion zone at a quantity ratio for a combustion with a lambda value in the range of 1-1.15.

12. A process in accordance with claim 11, wherein combustion air and fuel are fed to the combustion chamber assembly unit at such flow rates that the primary combustion air and the secondary combustion air and the fuel are fed into the combustion chamber at a quantity ratio for a combustion with a lambda value in the range of 1.6 to 1.8.

13. A process in accordance with claim 12, wherein:
the first combustion air feed device comprises a combustion air introduction attachment projecting in a direction of the combustion chamber at the combustion chamber bottom;
a plurality of first combustion air introduction openings are provided in a circumferential wall of the combustion air introduction attachment or/and in a bottom of the combustion air introduction attachment, which bottom is offset in the direction of the housing longitudinal axis in relation to the combustion chamber bottom; and
the second combustion air feed device comprises a plurality of second combustion air introduction openings in an area of the combustion chamber circumferential wall, which area is located at an axially spaced location in relation to the bottom of the combustion air introduction attachment.

14. A process in accordance with claim 13, wherein:
the first combustion air feed device comprises, upstream in relation to the combustion air introduction attachment, a swirl-generating device for introducing the primary combustion air with a swirl in relation to the housing longitudinal axis into the combustion air introduction attachment; or
the second combustion air feed device comprises a combustion air feed chamber enclosing the combustion chamber circumferential wall; or
the first combustion air feed device comprises, upstream in relation to the combustion air introduction attachment, a swirl-generating device for introducing the primary combustion air with a swirl in relation to the housing longitudinal axis into the combustion air introduction attachment and the second combustion air feed device comprises a combustion air feed chamber enclosing the combustion chamber circumferential wall.

15. A process in accordance with claim 13, wherein:
the porous evaporator medium extends on the inner side of the combustion chamber circumferential wall, starting from the combustion chamber bottom, axially beyond the combustion air introduction attachment; and
the second combustion air introduction openings are arranged at an axially spaced location from the porous evaporator medium.

16. A process in accordance with claim 12, wherein the first combustion air feed device and the second combustion air feed device are configured such that 57% to 61% of the combustion air introduced into the combustion chamber enters the combustion chamber as primary combustion air and 39% to 43% of the combustion air introduced into the combustion chamber enters the combustion chamber as secondary combustion air.
